(19) United States
(12) Patent Application Publication
(10) Pub. No.: US 2017/0210340 A1
(43) Pub. Date: Jul. 27, 2017

(54) AUTOMOBILE COMMUNICATION SYSTEM, AND CUSTOMIZATION METHOD FOR THE PARAMETERS OF A VEHICLE EQUIPPED WITH A KEYLESS ENTRY SYSTEM

(71) Applicant: DURA AUTOMOTIVE SYSTEMS SAS, Bievres (FR)

(72) Inventors: Arnaud Georges Thooris, Meudon (FR); Mickaël Roches, Saint Remy Les Chevreuse (FR)

(21) Appl. No.: 15/414,086

(22) Filed: Jan. 24, 2017

(30) Foreign Application Priority Data
Jan. 25, 2016 (FR) FR1650543

(51) Int. Cl. B60R 25/24

(52) U.S. Cl. CPC B60R 25/24; B60R 2325/101; B60R 2325/103; B60R 2325/205

(57) ABSTRACT

The present disclosure relates to an automobile communication system that may include: a user drivable vehicle, comprising customizable parameters and equipped with a keyless entry system; and a user portable personal electronic device that is configured for establishing a first wireless communication with the keyless entry system authorizing the user to access the vehicle. The system is characterized in that the personal electronic device comprises user parameters and is configured for establishing a second wireless communication with the keyless entry system updating the parameters of the vehicle with the user parameters. The disclosure also relates to a customization method for the parameters of a vehicle equipped with a keyless entry system.

### CROSS REFERENCE TO RELATED APPLICATIONS

This application claims priority to French Patent Application No. FR1650543 filed Jan. 25, 2016. The content of this priority application is incorporated herein by reference in its entirety.

### TECHNICAL FIELD

The present disclosure relates to an automobile communication system. The disclosure also relates to a customization method for the parameters of a vehicle equipped with a keyless entry device.

The technical field includes automobiles equipped with a keyless entry device.

### BACKGROUND

In a known manner, such a keyless entry device is paired with an electronic card carried by a user of the vehicle. This card is configured to establish a wireless communication with the keyless entry device, authorizing the user to access the vehicle, when the card is located at a preset distance from the device.

At least one purpose of the at least certain implementations of present invention is to propose an improved automobile communication system and also a customization method for the parameters of a vehicle equipped with a keyless entry device.

For this purpose, an automobile communication system may include:
a user drivable vehicle, comprising customizable parameters and equipped with a keyless entry device; and
a user portable personal electronic device that is configured for establishing a first wireless communication with the keyless entry system authorizing the user to access the vehicle.

The automobile communication system is characterized in that the personal electronic device comprises user parameters and is configured for establishing a second wireless communication with the keyless entry device updating the parameters of the vehicle with the user parameters.

The invention thus makes it easier for the driver or another user to personalize the vehicle depending on their respective preferences.

### SUMMARY

According to other advantageous characteristics of at least certain implementations of the invention, taken in isolation or in combination:
The first wireless communication is established automatically when the personal electronic device is located at a preset distance from the keyless entry system.
The second wireless communication is established only if the first wireless communication is already established.
The first wireless communication uses an NFC standard.
The second wireless communication uses a Bluetooth standard.
The personal electronic device is a mobile telephone.
The personal electronic device is a passive entry card.
The architecture comprises a remote data server.

The architecture comprises at least one other personal electronic device configured for communicating with the keyless entry device.

The subject of the disclosure is also a customization method for the parameters of a vehicle, equipped with a keyless entry system, characterized in that the method comprises the following successive steps:
a) A user of the vehicle brings a personal electronic device comprising the user parameters to a preset distance from the keyless entry system;
b) The personal electronic device establishes a first wireless communication with the keyless entry system authorizing the user to access the vehicle.
c) The personal electronic device establishes a second wireless communication with the keyless entry system, updating the parameters of the vehicle with the user parameters.

According to other advantageous characteristics, taken in isolation or in combination:
When the user changes the parameters of the vehicle during use, the user parameters are updated in the personal electronic device.
The user parameters can be modified directly on the personal electronic device by the user.
The initialization parameters recorded in a remote data server can be downloaded by the user to the personal electronic device.

The user parameters recorded in the personal electronic device can be transmitted by the user to a second personal electronic device.

### BRIEF DESCRIPTION OF THE ACCOMPANYING DRAWINGS

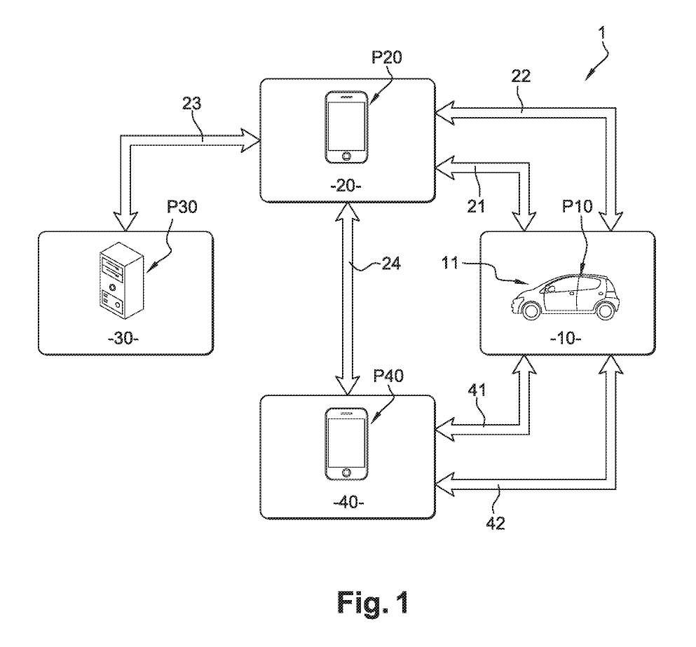

The disclosure will be better understood upon reading the following description, given solely as a nonlimiting example and made with reference to the attached FIG. 1, showing an automobile communication system 1.

### DETAILED DESCRIPTION

In the example of FIG. 1, the system 1 comprises an automobile vehicle 10, a first mobile telephone 20, a remote data server 30 and a second mobile telephone 40.

The vehicle 10 is designed to be driven by a user who is then the driver. The vehicle 10 comprises adjustable parameters P10, which are configurable by the driver or another user. As an example, these parameters P10 can include the position of the seats, the adjustment of the air conditioning and heating mechanism and the programming of the radio. Other vehicle parameters P10 can be customized without going beyond the scope of the invention.

The vehicle 10 is equipped with a keyless entry system 11, with which the user can automatically open and close the openings of the vehicle 10, under the conditions detailed below. The openings include the doors and trunk of the vehicle 10.

The telephone 20 is a smart telephone configured to communicate by means of various wireless communications standards (in particular LTE, NFC, Bluetooth, Wi-Fi, etc.) and for running various applications.

The telephone 20 may constitute a personal electronic device, user portable and paired with the keyless entry device 11 of the vehicle 10 for example via a dedicated application.

The telephone 20 is configured in such a way as to establish a first wireless communication 21 with the system 11 in order to authorize user access to the vehicle 10. The communication 21 preferably uses an NFC (Near Field Communication) standard. The communication 21 is established automatically when the telephone 20 is located a set distance from the system 11.

User parameters P20 corresponding to the adjustable parameters P10 of the vehicle 10 are recorded in the telephone 20.

The telephone 20 is configured to establish a second wireless communication 22 with the system 11 in order to update the parameters P10 of the vehicle 10 with the user parameters P20. Preferably the communication 22 uses a Bluetooth standard.

The communication 22 is established automatically when the communication 21 is already established with the system 11. Alternatively, the communication 22 can be established after automatic (by identification key) or manual (by password) authentication.

When the user changes the parameters P10 of the vehicle 10 during use, whether stopped or in motion, the user parameters P20 are automatically updated in the telephone 20 via the communication 22.

Additionally, the user parameters P20 can be changed by the user directly on the telephone 20, for example with the dedicated application.

The telephone 20 is configured to establish a wireless communication 23 with the server 30. Preferably the communication 23 uses a Wi-Fi or LTE standard or any other advanced mobile standard.

The user can thus download initialization parameters P30, specific to the vehicle 10, from the server 30 to their telephone 20. Subsequently, the parameters P20 recorded in the telephone 20 include the parameters P30.

According to a preferred embodiment, the initialization parameters P30 are needed in the telephone 20 in order to establish the communications 21 and 22 with the vehicle 10. For example these parameters P30 comprise the Bluetooth address of the vehicle 1 and an identification key. Thus the communication 21 is established automatically when the telephone 20 is located at a set distance from the system 11 and comprises the parameters P30 downloaded from the server 30.

The initialization parameters P30 can also include default values corresponding to the adjustable parameters P10 of the vehicle 10 such as the position of the seats, the adjustment of the air conditioning and heating system and the programming of the radio. Other parameters can be included P30 without going beyond the scope of the invention.

The telephone 40 also constitutes a personal electronic device paired with the keyless entry system 11 of the vehicle 10. User parameters P40 corresponding to the adjustable parameters P10 of the vehicle 10 is recorded in the telephone 40. The telephone 40 belongs to a second user, for example a family member, a friend or colleague of the user of the telephone 20.

The telephone 40 is configured to establish communications 41 and 42 with the device 1 that are analogous respectively to communications 21 and 22.

The telephones 20 and 40 are configured to establish a wireless communication 24 with each other. Thus, the telephone 20 can share parameters P20 with the telephone 40 replacing the parameters P40.

Additionally, the system 1 can be configured differently from FIG. 1 without going beyond the scope of the invention.

As a variant, the telephone 20 and/or 40 can be replaced by a passive entry card. This electronic card then constitutes the personal electronic device having the properties presented above for the telephone 20.

According to another variant, the system 1 can comprise more than two personal electronic devices 20 and 40 paired with the device 11 equipping the vehicle 10.

According to another variant, the system 1 can comprise several vehicles 10 equipped with devices 11 paired with the same device 20.

Additionally, the technical characteristics of the various embodiments and variants mentioned above can be, in whole or for some of them, combined with each other.

In that way, the system 1 and the configuration method can be adapted in terms of cost, ergonomics, functionality and performance.

1. An automobile communication system comprising:
a user drivable vehicle, comprising customizable parameters and equipped with a keyless entry system; and
a user portable personal electronic device that is configured for establishing a first wireless communication with the keyless entry device authorizing the user to access the vehicle;
wherein the personal electronic device comprises user parameters and is configured for establishing a second wireless communication with the keyless entry system updating the parameters of the vehicle with the user parameters.

2. The automobile communication system according to claim 1, wherein the first wireless communication is established automatically when the personal electronic device (20) is located at a preset distance from the keyless entry device.

3. The automobile communication system according claim 1, wherein the second wireless communication is established only if the first wireless communication is already established.

4. The automobile communication system according to claim 1, wherein the first wireless communication uses an NFC standard.

5. The automobile communication system according to claim 1, wherein the second wireless communication uses a Bluetooth standard.

6. The automobile communication system according to claim 1, wherein the personal electronic device is a mobile telephone.

7. The automobile communication system according to claim 1, wherein the personal electronic device is a passive entry card.

8. A customization method for the parameters of a vehicle, equipped with a keyless entry device, wherein the method comprises the following successive steps:
a) a user of the vehicle brings a personal electronic device comprising the user parameters to a preset distance from the keyless entry system;
b) the personal electronic device stablishes a first wireless communication with the keyless entry system authorizing the user to access the vehicle;
c) the personal electronic device establishes a second wireless communication with the keyless entry system, updating the parameters of the vehicle with the user parameters.

9. The method according to claim 8, wherein, when the user changes the parameters of the vehicle during use, the user parameters are updated in the personal electronic device.

10. The method according to claim 8, wherein the user parameters can be modified directly on the personal electronic device by the user.

11. The method according to claim 8, wherein the initialization parameters recorded in a remote data server can be downloaded by the user into the personal electronic device.

12. The method according to claim 8, wherein the initialization parameters recorded in the personal electronic device can be transmitted by the user to a second personal electronic device.

13. The automobile communication system according claim 2, wherein the second wireless communication is established only if the first wireless communication is already established.

14. The method according claim 9, wherein the user parameters can be modified directly on the personal electronic device by the user.

15. The method according to claim 9, wherein the initialization parameters recorded in a remote data server can be downloaded by the user into the personal electronic device.

16. The method according to claim 10, wherein the initialization parameters recorded in a remote data server can be downloaded by the user into the personal electronic device.

17. The method according to claim 9, wherein the initialization parameters recorded in the personal electronic device can be transmitted by the user to a second personal electronic device.

18. The method according to claim 10, wherein the initialization parameters recorded in the personal electronic device can be transmitted by the user to a second personal electronic device.

19. The method according to claim 11, wherein the initialization parameters recorded in the personal electronic device can be transmitted by the user to a second personal electronic device.
